(19) United States
(12) Patent Application Publication
(10) Pub. No.: US 2017/0153477 A1
(43) Pub. Date: Jun. 1, 2017

(54) Display Panel and Liquid Crystal Display

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 14/773,353

(22) PCT Filed: Jul. 29, 2015
(86) PCT No.: PCT/CN2015/085377

§ 371 Date: Sep. 6, 2015

(30) Foreign Application Priority Data
Jul. 27, 2015 (CN) 201510448290.0

(51) Int. Cl. G02F 1/13363; G02F 1/1368; G02F 1/1335

(52) U.S. Cl. CPC G02F 1/13363; G02F 1/133514; G02F 1/1368; G02F 1/133555; G02F 1/133533; G02F 2201/121; G02F 2201/123; G02F 2001/133638; G02F 2001/133565

(57) ABSTRACT

The present invention discloses a display panel and a liquid crystal display. The display panel comprises a color filter substrate, a TFT substrate, and a liquid crystal layer located between the color filter substrate and the TFT substrate. The display panel comprises multiple pixel areas distributed in array, and each pixel area comprises a transmission region and a reflex region which are divided along the vertical direction of the TFT substrate. The thicknesses of the liquid crystal layer in the transmission region and the reflex region are the same. In the transmission region, a phase retardation plate is further provided between the liquid crystal layer and the TFT substrate or between the liquid crystal layer and the color filter substrate. Through the above way, the present invention can reduce poor alignment of liquid crystal and light leakage in dark state during brush grinding step, and decrease the process difficulty.

### BACKGROUND OF THE INVENTION

1. Field of the Invention

The present invention relates to the field of displaying techniques, and in particular to a display panel and a liquid crystal display.

2. The Related Arts

Liquid crystal display panel generally consists of a color filter substrate and an array substrate. The space between the two substrates encapsulates the liquid crystal layer. Since the liquid crystal molecules themselves do not emit light, the display panel requires a light source to display an image. Depending on the type of the light source, the liquid crystal display can be divided into transmissive, reflective and transflective.

Transflective liquid crystal display panel can be regarded as binding transmissive and reflective liquid crystal display panel. On the array substrate, it is provided with both a reflex region and a transmission region, which can utilize backlight and front light or external light source for display.

Transflective liquid crystal display panel combines the advantages of panel transmissive and reflective liquid crystal display. It can display bright image in a dark environment, indoor use, and outdoor use. Therefore, it is widely used in the display equipment of the portable electronic products.

However, this arrangement has some drawbacks. Because a gap (height difference) will be formed at the junction of the transmission region and the reflex region due to the different film thickness, which will cause the alignment disorder of the liquid crystal and poor alignment of liquid crystal and light leakage in dark state during brush grinding step.

### SUMMARY OF THE INVENTION

The technical issue to be solved by the present invention is to provide a display panel and a liquid crystal display, which can reduce poor alignment of liquid crystal and light leakage in dark state during brush grinding step, simplify the structure, and decrease the process difficulty.

In order to solve the above issue, a technical solution adopted by the present invention is to provide a display panel, wherein, the display panel comprises a color filter substrate, a thin-film transistor (TFT) substrate, and a liquid crystal layer located between the color filter substrate and the TFT substrate; wherein, the display panel comprises multiple pixel areas distributed in array, each pixel area comprises a transmission region and a reflex region which are divided along the vertical direction of the TFT substrate, the thicknesses of the liquid crystal layer in the transmission region and the reflex region are the same; wherein, in the transmission region, a phase retardation plate is further provided between the liquid crystal layer and the TFT substrate or between the liquid crystal layer and the color filter substrate; wherein, the liquid crystal layer is a positive liquid crystal layer, the phase delay of the liquid crystal layer is ¼λ, the phase delay of the phase retardation plate is ¼λ, and the phase delay of the transmission region is ½λ.

Wherein, in the reflex region, a reflective layer is further provided between the liquid crystal layer and the TFT substrate.

Wherein, the phase delay of the liquid crystal layer is ¼λ, the phase delay that the light passes through the liquid crystal layer again, after the light passes through the liquid crystal layer and then is reflected by the reflective layer, is ½λ.

Wherein, in the reflex region, the reflective layer is located at the side of the TFT substrate adjacent to the liquid crystal layer; in the transmission region, the phase retardation plate is located at the side of the TFT substrate adjacent to the liquid crystal layer.

Wherein, the side of the color filter substrate adjacent to the liquid crystal layer further comprises a common electrode, the side thereof away from the liquid crystal layer further comprises a color film polaroid.

Wherein, the side of the TFT substrate adjacent to the liquid crystal layer further comprises a pixel electrode, the side thereof away from the liquid crystal layer further comprises a TFT polaroid.

In order to solve the above issue, another technical solution adopted by the present invention is to provide a display panel, wherein, the display panel comprises a color filter substrate, a thin-film transistor (TFT) substrate, and a liquid crystal layer located between the color filter substrate and the TFT substrate; wherein, the display panel comprises multiple pixel areas distributed in array, each pixel area comprises a transmission region and a reflex region which are divided along the vertical direction of the TFT substrate, the thicknesses of the liquid crystal layer in the transmission region and the reflex region are the same; wherein, in the transmission region, a phase retardation plate is further provided between the liquid crystal layer and the TFT substrate or between the liquid crystal layer and the color filter substrate.

Wherein, the phase delay of the liquid crystal layer is ¼λ, the phase delay of the phase retardation plate is ¼λ, and the phase delay of the transmission region is ½λ.

Wherein, the phase retardation plate is formed on the TFT substrate or the color filter substrate using a coating method.

Wherein, in the reflex region, a reflective layer is further provided between the liquid crystal layer and the TFT substrate.

Wherein, the phase delay of the liquid crystal layer is ¼λ, the phase delay that the light passes through the liquid crystal layer again, after the light passes through the liquid crystal layer and then is reflected by the reflective layer, is ½λ.

Wherein, in the reflex region, the reflective layer is located at the side of the TFT substrate adjacent to the liquid crystal layer; in the transmission region, the phase retardation plate is located at the side of the TFT substrate adjacent to the liquid crystal layer.

Wherein, the liquid crystal layer is a positive liquid crystal layer.

Wherein, the side of the color filter substrate adjacent to the liquid crystal layer further comprises a common electrode, the side thereof away from the liquid crystal layer further comprises a color film polaroid.

Wherein, the side of the TFT substrate adjacent to the liquid crystal layer further comprises a pixel electrode, the side thereof away from the liquid crystal layer further comprises a TFT polaroid.

In order to solve the above issue, another technical solution adopted by the present invention is to provide a liquid crystal display, wherein, the liquid crystal display comprises a display panel and a backlight source, wherein the display panel comprises a color filter substrate, a thin-film transistor (TFT) substrate, and a liquid crystal layer located between the color filter substrate and the TFT substrate; wherein, the display panel comprises multiple pixel areas distributed in array, each pixel area comprises a transmission region and a reflex region which are divided along the vertical direction of the TFT substrate, the thicknesses of the liquid crystal layer in the transmission region and the reflex region are the same; wherein, in the transmission region, a phase retardation plate is further provided between the liquid crystal layer and the TFT substrate or between the liquid crystal layer and the color filter substrate.

Wherein, the liquid crystal layer is a positive liquid crystal layer, the phase delay of the liquid crystal layer is ¼λ, the phase delay of the phase retardation plate is ¼λ, and the phase delay of the transmission region is ½λ.

Wherein, the phase retardation plate is formed on the TFT substrate or the color filter substrate using a coating method.

Wherein, in the reflex region, a reflective layer is further provided between the liquid crystal layer and the TFT substrate; the phase delay of the liquid crystal layer is ¼λ, the phase delay that the light passes through the liquid crystal layer again, after the light passes through the liquid crystal layer and then is reflected by the reflective layer, is ½λ.

The present invention has following benefits. Different from the prior art, the present invention discloses a display panel. The display panel comprises a color filter substrate, a thin-film transistor (TFT) substrate, and a liquid crystal layer located between the color filter substrate and the TFT substrate. The display panel comprises multiple pixel areas distributed in array, and each pixel area comprises a transmission region and a reflex region which are divided along the vertical direction of the TFT substrate. The thicknesses of the liquid crystal layer in the transmission region and the reflex region are the same. In the transmission region, a phase retardation plate is further provided between the liquid crystal layer and the TFT substrate or between the liquid crystal layer and the color filter substrate. That is, the phase retardation plate is added in the transmission region to increase the phase delay amount of light passing through the area, so that the phase delay amount of light passing through the transmission area once is equal to that of light passing through the transmission area twice. Therefore, the liquid crystal display is single box thickness, which can reduce poor alignment of liquid crystal and light leakage in dark state during brush grinding step, simplify the structure, and decrease the process difficulty.

### BRIEF DESCRIPTION OF THE DRAWINGS

FIG. 1 is a schematic view illustrating the structure of the transflective liquid crystal display according to the existing technology;

FIG. 2 is a schematic view illustrating the structure of the display panel according to the first embodiment of the present invention;

FIG. 3 is a schematic view illustrating the structure of the display panel according to the second embodiment of the present invention;

FIG. 4 is a schematic view illustrating the optical path of the display panel according to the second embodiment of the present invention; and

FIG. 5 is a schematic view illustrating the structure of the liquid crystal display according to one embodiment of the present invention.

### DETAILED DESCRIPTION OF THE PREFERRED EMBODIMENTS

Referring to FIG. 1, FIG. 1 is a schematic view illustrating the structure of the transflective liquid crystal display according to the existing technology. Each pixel area in the transflective liquid crystal display according to the existing technology is divided into a transmission region and a reflex region. Each area is composed of a color filter substrate 110, an array substrate 120, and a liquid crystal layer 130 located between the color filter substrate 110 and the array substrate 120. A reflective layer 150 and a resin layer 160 are further provided between the liquid crystal layer 130 and the array substrate 120 in the reflex region. When the light is incident from the color filter substrate 110 in the reflex region, it will be reflected after reaching the reflective layer 150, that is, the light passes through the liquid crystal layer 130 twice. Therefore, the phase delay thereof is twice as light passing through the liquid crystal layer 130 once.

For these reasons, in the transmission region of the display panel according to existing technology, in order to make the phase delay of light achieves the same level as the phase delay of the reflective area, it will increase the thickness of the liquid crystal layer 130 in the transmission region, so that the thicknesses of the liquid crystal layer 130 in the transmission region and the reflex region are different. Therefore, it needs to add a layer of the resin layer 160. But, it will cause the alignment disorder of the liquid crystal, leading to the poor alignment of liquid crystal and light leakage in dark state during brush grinding step. The display panel provided in the embodiment of the present invention is used to solve the above problem. The detailed descriptions accompanying drawings and the embodiment of the present invention are as follows.

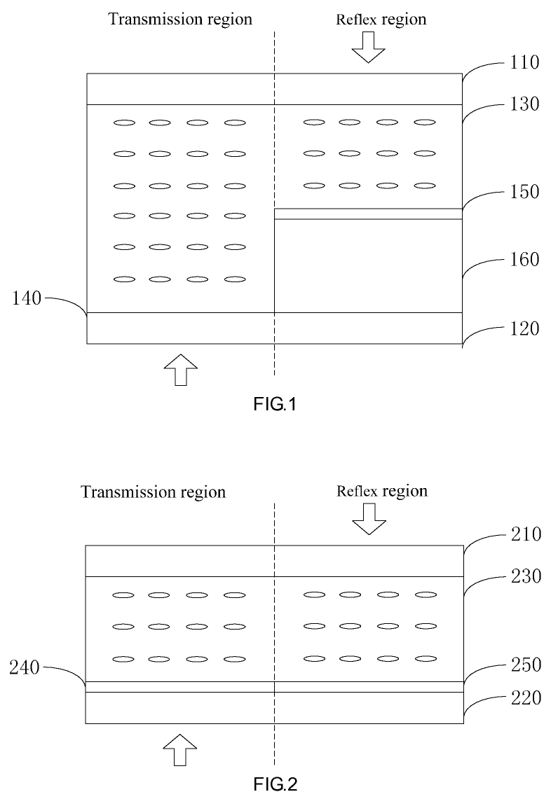

Referring to FIG. 2, it shows a schematic view illustrating the structure of the display panel according to the first embodiment of the present invention. The display panel comprises a color filter substrate 210, a thin-film transistor (TFT) substrate 220, and a liquid crystal layer 230 located between the color filter substrate 210 and the TFT substrate 230. The display panel comprises multiple pixel areas distributed in array. Each pixel area comprises a transmission region and a reflex region which are divided along the vertical direction of the TFT substrate 220. The thicknesses of the liquid crystal layer in the transmission region and the reflex region are the same. In the transmission region, a phase retardation plate 240 is further provided between the liquid crystal layer 230 and the TFT substrate 220 or between the liquid crystal layer 230 and the color filter substrate 210. As shown in FIG. 2, in the present embodiment, the phase retardation plate 240 is provided between the liquid crystal layer 230 and the TFT substrate 220.

The said pixel area can be the transparent area in the pixel structure. For example, the inner side of the TFT substrate 220 adjacent to the liquid crystal layer 230 can further comprises a gate line and the data line cross the gate line. The gate line and the data line define multiple pixel areas. The inner side of the color filter substrate 210 adjacent to the liquid crystal layer 230 is provided with a black matrix pattern, and red, green and blue filter structure distributed in array. Wherein, the black matrix pattern corresponds to the gate line and the data line cross to each other. Of course, this is only one example, it should not be construed as limiting the present invention.

The function of the phase retardation plate 240 is to make the light passing through generate the phase delay. Therefore, the phase retardation plate 240 can be provided at the upper surface or lower surface of the liquid crystal layer 230. In the other embodiment, the phase retardation plate can also be provided at the other place, such as one side of the TFT substrate 220 away from the liquid crystal layer 230.

At the same time, the phase delay amount of the phase delay plate 240 can be set as desired. In the present embodiment, in order to make the light phase delay amount in the transmission region equal to that in the reflex region, it can set the phase delay amount of the phase delay plate 240 as the phase delay amount of the single box thickness liquid crystal layer.

Distinguished from the prior art, the present embodiment discloses a display panel, which comprises a color filter substrate, a TFT substrate, and a liquid crystal layer located between the color filter substrate and the TFT substrate. The display panel comprises multiple pixel areas distributed in array, and each pixel area comprises a transmission region and a reflex region which are divided along the vertical direction of the TFT substrate. The thicknesses of the liquid crystal layer in the transmission region and the reflex region are the same. In the transmission region, a phase retardation plate is further provided between the liquid crystal layer and the TFT substrate or between the liquid crystal layer and the color filter substrate. That is, the phase retardation plate is added in the transmission region to increase the phase delay amount of light passing through the area, so that the phase delay amount of light passing through the transmission area once is equal to that of light passing through the transmission area twice. Therefore, the liquid crystal display is single box thickness, which can reduce poor alignment of liquid crystal and light leakage in dark state during brush grinding step, simplify the structure, and decrease the process difficulty.

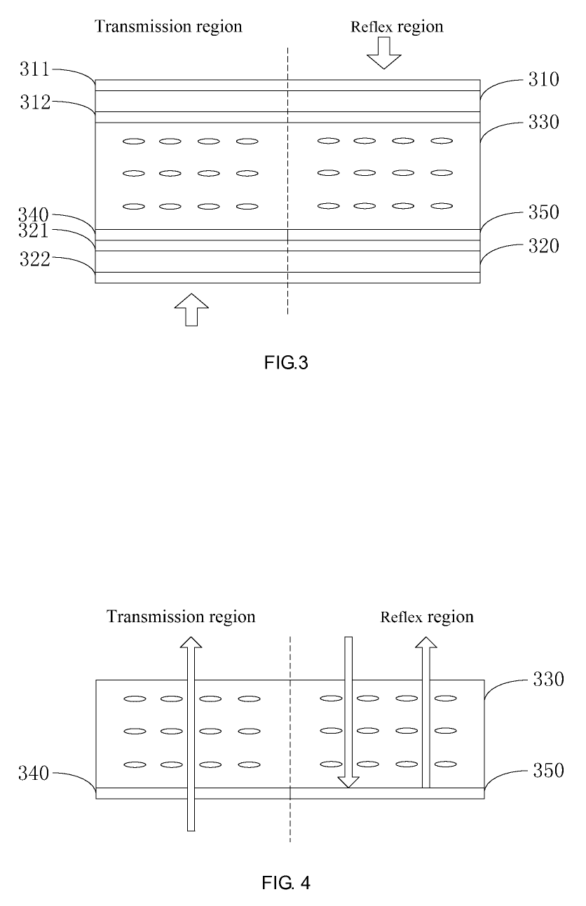

Referring to FIG. 3, it shows a schematic view illustrating the structure of the display panel according to the second embodiment of the present invention. The display panel comprises a color filter substrate 310, a thin-film transistor (TFT) substrate 2320, and a liquid crystal layer 330 located between the color filter substrate 310 and the TFT substrate 330. The display panel comprises multiple pixel areas distributed in array. Each pixel area comprises a transmission region and a reflex region which are divided along the vertical direction of the TFT substrate 320. The thicknesses of the liquid crystal layer in the transmission region and the reflex region are the same. In the transmission region, a phase retardation plate 340 is further provided between the liquid crystal layer 330 and the TFT substrate 320.

In the reflex region, a reflective layer 350 is further provided between the liquid crystal layer 330 and the TFT substrate 320. The reflective layer 350 is used to reflect the incident light from the color filter substrate 310 in the reflex region after passing through the liquid crystal layer 330.

In the present embedment, in the reflex region, the reflective layer 350 is located at the side of the TFT substrate 320 adjacent to the liquid crystal layer 330; in the transmission region, the phase retardation plate 340 is formed on the TFT substrate 320 or the color filter substrate 310 using a coating method. In the present embodiment, the phase retardation plate 340 is located at the side of the TFT substrate 320 adjacent to the liquid crystal layer 330. That is, the phase retardation plate 340 and the reflective layer 350 are arranged side by side

The side of the color filter substrate 310 adjacent to the liquid crystal layer 330 further comprises a common electrode 312, the side thereof away from the liquid crystal layer 330 further comprises a color film polaroid 311.

The side of the TFT substrate 320 adjacent to the liquid crystal layer 330 further comprises a pixel electrode 321, the side thereof away from the liquid crystal layer 330 further comprises a TFT polaroid 321.

Specifically, the shape of the common electrode 312 and the pixel electrode 321 may be provided as needed, such as strip electrodes. Of course, the pixel electrode 321 is provided between the phase retardation plate 340 and the TFT substrate 320, and between the reflective layer 350 and the TFT substrate 320.

Referring to FIG. 4, it shows a schematic view illustrating the optical path of the display panel according to the second embodiment of the present invention. In the present embodiment, the liquid crystal layer 330 is a positive liquid crystal layer. The phase delay of the liquid crystal layer 330 is ¼λ. Therefore, in the reflex region, because the light will pass through the liquid crystal layer 330 twice after reflected by the reflective layer 350, the phase delay, that the light enters the reflex region and is reflected, is ¼λ+¼λ=½λ. In order to make the phase delay in the transmission region matches the phase delay in the reflex region, it should provide a phase retardation plate with the phase delay amount of ¼λ, so that the phase delay in the transmission region will also be ¼λ+¼λ=½λ.

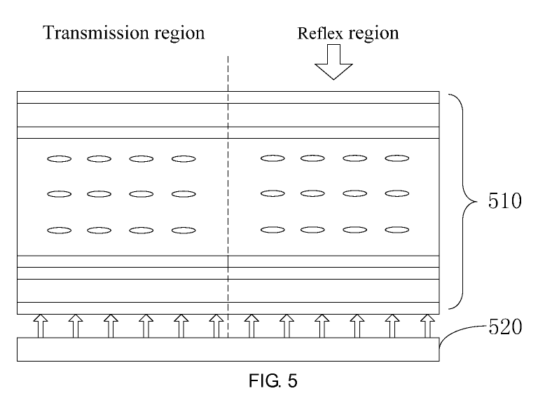

Referring to FIG. 5, it shows a schematic view illustrating the structure of the liquid crystal display according to one embodiment of the present invention. The liquid crystal display comprises a backlight source 520. The liquid crystal display further comprises a display panel 510. The display panel 510 can refer to the description as FIG. 2-4, which is not repeated here.

Distinguished from the prior art, the present embodiment discloses a liquid crystal display, which comprises a backlight source and a display panel. The display panel comprises a color filter substrate, a thin-film transistor (TFT) substrate, and a liquid crystal layer located between the color filter substrate and the TFT substrate. The display panel comprises multiple pixel areas distributed in array, and each pixel area comprises a transmission region and a reflex region which are divided along the vertical direction of the TFT substrate. The thicknesses of the liquid crystal layer in the transmission region and the reflex region are the same. In the transmission region, a phase retardation plate is further provided between the liquid crystal layer and the TFT substrate or between the liquid crystal layer and the color filter substrate. That is, the phase retardation plate is added in the transmission region to increase the phase delay amount of light passing through the area, so that the phase delay amount of light passing through the transmission area once is equal to that of light passing through the transmission area twice. Therefore, the liquid crystal display is single box thickness, which can reduce poor alignment of liquid crystal and light leakage in dark state during brush grinding step, simplify the structure, and decrease the process difficulty.

The above described embodiments of the invention only, and not limit, the patent scope of the present invention, therefore, the use of all the contents of the accompanying drawings and the description of the present invention is made to equivalent structures or equivalent conversion process, e.g., between the embodiments example technology mutually binding characteristics, directly or indirectly related to the use of technology in other fields, are included within the scope of patent empathy protection of the invention.

What is claimed is:

1. A display panel, wherein, the display panel comprises a color filter substrate, a thin-film transistor (TFT) substrate, and a liquid crystal layer located between the color filter substrate and the TFT substrate;
wherein, the display panel comprises multiple pixel areas distributed in array, each pixel area comprises a transmission region and a reflex region which are divided along the vertical direction of the TFT substrate, the thicknesses of the liquid crystal layer in the transmission region and the reflex region are the same;
wherein, in the transmission region, a phase retardation plate is further provided between the liquid crystal layer and the TFT substrate or between the liquid crystal layer and the color filter substrate;
wherein, the liquid crystal layer is a positive liquid crystal layer, the phase delay of the liquid crystal layer is ¼λ, the phase delay of the phase retardation plate is ¼λ, and the phase delay of the transmission region is ½λ.

2. The display panel as claimed in claim 1, wherein the phase retardation plate is formed on the TFT substrate or the color filter substrate using a coating method.

3. The display panel as claimed in claim 1, wherein, in the reflex region, a reflective layer is further provided between the liquid crystal layer and the TFT substrate.

4. The display panel as claimed in claim 3, wherein the phase delay of the liquid crystal layer is ¼λ, the phase delay that the light passes through the liquid crystal layer again, after the light passes through the liquid crystal layer and then is reflected by the reflective layer, is ½λ.

5. The display panel as claimed in claim 4, wherein, in the reflex region, the reflective layer is located at the side of the TFT substrate adjacent to the liquid crystal layer; in the transmission region, the phase retardation plate is located at the side of the TFT substrate adjacent to the liquid crystal layer.

6. The display panel as claimed in claim 1, wherein the side of the color filter substrate adjacent to the liquid crystal layer further comprises a common electrode, the side thereof away from the liquid crystal layer further comprises a color film polaroid.

7. The display panel as claimed in claim 1, wherein the side of the TFT substrate adjacent to the liquid crystal layer further comprises a pixel electrode, the side thereof away from the liquid crystal layer further comprises a TFT polaroid.

8. A display panel, wherein, the display panel comprises a color filter substrate, a thin-film transistor (TFT) substrate, and a liquid crystal layer located between the color filter substrate and the TFT substrate;
wherein, the display panel comprises multiple pixel areas distributed in array, each pixel area comprises a transmission region and a reflex region which are divided along the vertical direction of the TFT substrate, the thicknesses of the liquid crystal layer in the transmission region and the reflex region are the same;
wherein, in the transmission region, a phase retardation plate is further provided between the liquid crystal layer and the TFT substrate or between the liquid crystal layer and the color filter substrate.

9. The display panel as claimed in claim 8, wherein the phase delay of the liquid crystal layer is ¼λ, the phase delay of the phase retardation plate is ¼λ, and the phase delay of the transmission region is ½λ.

10. The display panel as claimed in claim 9, wherein the phase retardation plate is formed on the TFT substrate or the color filter substrate using a coating method.

11. The display panel as claimed in claim 8, wherein, in the reflex region, a reflective layer is further provided between the liquid crystal layer and the TFT substrate.

12. The display panel as claimed in claim 11, wherein the phase delay of the liquid crystal layer is ¼λ, the phase delay that the light passes through the liquid crystal layer again, after the light passes through the liquid crystal layer and then is reflected by the reflective layer, is ½λ.

13. The display panel as claimed in claim 12, wherein in the reflex region, the reflective layer is located at the side of the TFT substrate adjacent to the liquid crystal layer; in the transmission region, the phase retardation plate is located at the side of the TFT substrate adjacent to the liquid crystal layer.

14. The display panel as claimed in claim 8, wherein the liquid crystal layer is a positive liquid crystal layer.

15. The display panel as claimed in claim 8, wherein the side of the color filter substrate adjacent to the liquid crystal layer further comprises a common electrode, the side thereof away from the liquid crystal layer further comprises a color film polaroid.

16. The display panel as claimed in claim 8, wherein the side of the TFT substrate adjacent to the liquid crystal layer further comprises a pixel electrode, the side thereof away from the liquid crystal layer further comprises a TFT polaroid.

17. A liquid crystal display, wherein, the liquid crystal display comprises a display panel and a backlight source, wherein the display panel comprises a color filter substrate, a thin-film transistor (TFT) substrate, and a liquid crystal layer located between the color filter substrate and the TFT substrate;
wherein, the display panel comprises multiple pixel areas distributed in array, each pixel area comprises a transmission region and a reflex region which are divided along the vertical direction of the TFT substrate, the thicknesses of the liquid crystal layer in the transmission region and the reflex region are the same;
wherein, in the transmission region, a phase retardation plate is further provided between the liquid crystal layer and the TFT substrate or between the liquid crystal layer and the color filter substrate.

18. The liquid crystal display as claimed in claim 17, wherein the liquid crystal layer is a positive liquid crystal layer, the phase delay of the liquid crystal layer is ¼λ, the phase delay of the phase retardation plate is ¼λ, and the phase delay of the transmission region is ½λ.

19. The liquid crystal display as claimed in claim 18, wherein the phase retardation plate is formed on the TFT substrate or the color filter substrate using a coating method.

20. The liquid crystal display as claimed in claim 17, wherein, in the reflex region, a reflective layer is further provided between the liquid crystal layer and the TFT substrate;
wherein, the phase delay of the liquid crystal layer is ¼λ, the phase delay that the light passes through the liquid crystal layer again, after the light passes through the liquid crystal layer and then is reflected by the reflective layer, is ½λ.
